(19) United States
(12) Patent Application Publication
(10) Pub. No.: US 2019/0156356 A1
(43) Pub. Date: May 23, 2019

(54) SYSTEMS AND METHODS FOR TRACKING MEDIA CONTENT CONSUMPTION

(71) Applicant: MASTERCARD INTERNATIONAL INCORPORATED, Purchase, NY (US)

(72) Inventor: Justin X. Howe, San Francisco, CA (US)

(73) Assignee: MASTERCARD INTERNATIONAL INCORPORATED, Purchase, NY (US)

(21) Appl. No.: 16/259,291

(22) Filed: Jan. 28, 2019

Related U.S. Application Data
(63) Continuation of application No. 14/713,052, filed on May 15, 2015.

(51) Int. Cl. G06Q 30/02

(52) U.S. Cl. CPC G06Q 30/0201

(57) ABSTRACT

Systems and methods for tracking media content consumption and developing a media content consumption database are disclosed. Media purchase data is received and analyzed to determine media content items purchased in individual media content transactions. The media content transactions are compared to payment account data to determine a corresponding account number. The media content items purchased and corresponding account number are then stored in a media content consumption database.

### CROSS-REFERENCE TO RELATED APPLICATION DATA

This application is a continuation of U.S. patent application Ser. No. 14/713,052 filed May 15, 2015 the disclosure of which is incorporated by reference herein.

### FIELD OF TECHNOLOGY

The present disclosure relates generally to tracking media content consumption.

### BACKGROUND

Consumers may access media content via multiple delivery systems. If a consumer wishes to watch a movie, for example, the consumer may purchase/rent a physical copy of media content at a physical store, purchase/rent a digital copy of media content at a physical or virtual store, attend a movie at a cinema, rent and watch a movie during an airline flight or the consumer may have access to an unlimited number of movies and TV shows via a physical or online media content subscription. To further diffuse and segregate multimedia content consumption, each delivery system may be offered by multiple competing media content providers. Thus, item(s) of media content may be offered using multiple competing media content providers over multiple competing delivery systems.

In order to better understand the behavior of consumers and provide additional information regarding consumption of media content, it may be beneficial to collate and/or analyze media content consumption and/or purchases. However, while each media content provider may individually track media content consumption for individual consumers, media content consumption is not readily accessible or collated for individual consumers between the multiple media content providers.

### SUMMARY

A special purpose computer system is configured so that media purchases may be tagged on a payment network and tracked on the computer system specially configured for that function, and automatically associated with an account that allows aggregation of media transaction data on an individual basis. The transaction data, in a data warehouse or database, generally may include different categories, such as consumer credit card transaction data, consumer debit card transaction data and commercial credit card transaction data, for example. The transaction data, generally, may indicate transaction amounts, location, product or service types, a transaction product segment or categories, and numerous other transaction classifications, for example, and from that data media purchase transaction data may be determined according to the present disclosure. The media purchase transaction data may be tagged and associated with a user account, and may further include data descriptive of media purchase transactions of various types, and in various different countries and/or regions, for example.

More specifically, the special purpose computer retrieves payment account data from an account database, the payment account data including one or more transactions associated with one or more account numbers within a period of time. The system receives media consumption data, the media consumption data including one or more media purchase, lease or license transactions. Purchased media items are determined from the media consumption data. The purchased media items are correlated to the one or more transactions in the payment account data to infer a first account number from the one or more account numbers, and the purchased media items are associated with the first account number of the one or more account numbers in a media tracking database.

### BRIEF DESCRIPTION OF THE DRAWINGS

The features, nature, and advantages of the present disclosure will become more apparent from the detailed description set forth below when taken in conjunction with the drawings in which like reference characters identify corresponding aspects throughout.

FIG. 1 is a network diagram illustrating network(s) connecting a variety of devices including a media purchase tracking device according to aspects of the present disclosure.

FIG. 2 is a block diagram illustrating a general example of a credit card transaction system according to aspects of the present disclosure.

FIG. 3 is a block diagram illustrating a method for tracking media purchases according to aspects of the present disclosure.

FIG. 4 is a block diagram illustrating a method for updating a media purchase database according to aspects of the present disclosure.

FIG. 5 is a block diagram illustrating a media purchase tracking device according to aspects of the present disclosure.

### DETAILED DESCRIPTION OF EMBODIMENTS

According to aspects of the present disclosure, media purchases may be tagged on a payment network and tracked on a computer system specially configured for that function, and automatically associated with an account that allows aggregation of media transaction data on an individual basis. The transaction data, in a data warehouse or database, generally may include different categories, such as consumer credit card transaction data, consumer debit card transaction data and commercial credit card transaction data, for example. The transaction data, generally, may indicate transaction amounts, location, product or service types, a transaction product segment or categories, and numerous other transaction classifications, for example, and from that data media purchase transaction data may be determined according to the present disclosure. The media purchase transaction data may be tagged and associated with a user account, and may further include data descriptive of media purchase transactions of various types, and in various different countries and/or regions, for example.

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may be include plural embodiments, and references to more than one component may include a singular component.

The terms “card,” “payroll card” and “payment card” may be used interchangeably herein to describe a card that can be presented by the cardholder to make a payment or that can be used to make a payment in a remote transaction, such as an e-commerce transaction, telephone transaction, or mail order for example. The remote transactions such as e-commerce transactions, telephone transactions and mail order transactions, in which the card is not presented directly to a merchant during the transaction, are referred to herein as card-not-present (“CNP”) transactions. Payment cards may also include pre-paid cards such as payroll cards or general purpose reloadable cards. Payroll or reloadable cards generally provide a mechanism to pay employees efficiently as an alternative to issuing payroll checks, and may be used in contexts where the employee does not have a regular relationship with a banking institution such as a savings account, checking account, credit or debit card account. The term “card” may also be used in a context where a physical card, per se, is not necessary. Rather an electronic user device may be involved. Cards and personal devices may more broadly be termed “payment devices”.

The terminology used herein is for the purpose of describing particular embodiments only and is not intended to be limiting of the present disclosure. As used herein, the term “media content” may collectively or individually refer to video content, audio content, video game content and/or any other multimedia content. Examples of video content may include documentaries, video clips, movies, television shows and/or any other video content, while examples of audio content may include music, audiobooks, lectures and/or any other audio content. Media content may also include audio-visual content such as games, applications, or the like. Media content consumption may include purchasing the media content, viewing the media content, listening to the media content, playing the media content or accessing the media content. For example, media content consumption may occur when a consumer purchases or rents media content and/or accesses the media content using a subscription based service.

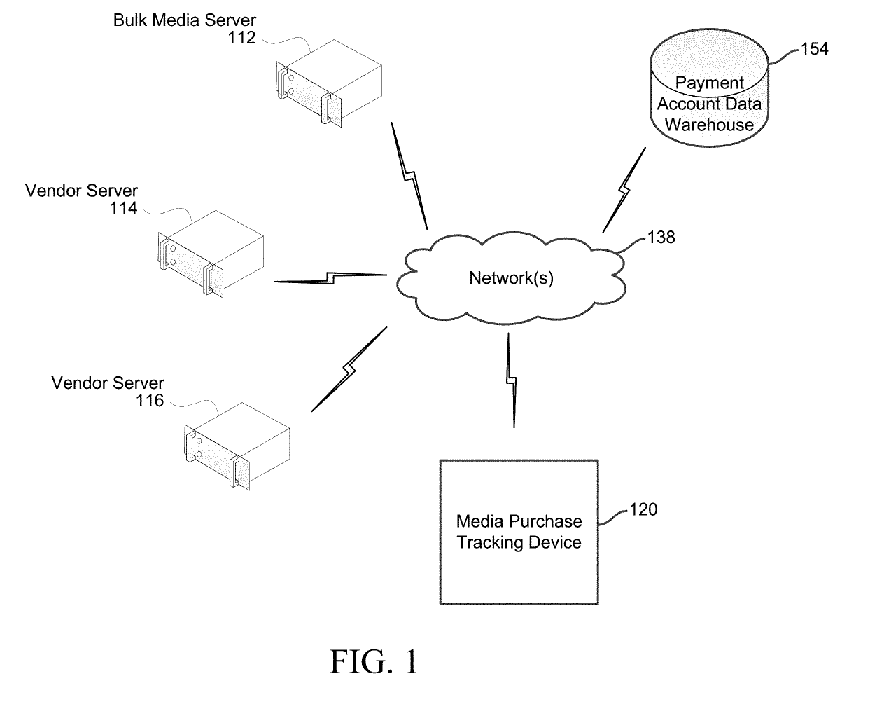

FIG. 1 is a network diagram illustrating network(s) 138 connecting a variety of devices including a media purchase tracking device 120 according to aspects of the present disclosure. As illustrated in FIG. 1, the media purchase tracking device 120 may be connected to the payment account data warehouse 154, a bulk media server 112, a first vendor server 114 and a second vendor server 116. However, the disclosure is not limited thereto and the media purchase tracking device 120 may be connected to any device available on the network(s) 138.

The payment account data warehouse 154 may store payment account data for individual account(s). For example, the payment account data may include transaction data associated with individual account number(s), the transaction data including a transaction amount, purchase location, product or service types, and/or additional transaction information for one or more transactions. The individual account(s) may include one or more accounts associated with an individual or a household. For example, an individual may have two accounts and a spouse of the individual may have a third account. These accounts may have unique account numbers and may be stored as separate accounts. Alternatively, these accounts may be grouped together as a household account and either have unique account numbers or a combined account number. The media purchase tracking device 120 may access the payment account data provided by the payment account data warehouse 154 and may cross reference various transactions to individual account number(s).

The media purchase tracking device 120 may receive bulk media purchase data from a third party data source such as the bulk media server 112. Examples of bulk media purchase data may include a list of media purchase transactions and/or a list of media content items. For example, bulk media purchase data may list one or more stock keeping unit(s) (SKU) associated with media content item(s) and corresponding media purchase transaction information based on combined purchasing details from thousands of retailers. While the bulk media purchase data may include reference numbers associated with individual media purchase transactions, the reference numbers provided may not correspond to account numbers utilized by the media purchase tracking device 120. Thus, the media purchase tracking device 120 may cross reference the bulk media purchase data with the payment account data provided by the payment account data warehouse 154 to determine corresponding account numbers. For example, the media purchase tracking device 120 may associate a reference number and/or transaction(s) included in the bulk media purchase data with an account number using payment account data such as dollar amount, merchant, transaction date/time and/or loyalty card number.

The media purchase tracking device 120 may also receive media purchase data, including media purchase transaction(s) associated with individual account(s), from the payment account data warehouse 154. The payment account data warehouse 154 and/or the media purchase tracking device 120 may receive media purchase data via clearing addenda, which may be payment card addenda having additional information related to individual transactions. For example, some transactions may include SKU level detail in the clearing addenda and the media purchase tracking device 120 may associate individual media content item(s) with a corresponding account number. The media purchase tracking device 120 may combine the media purchase data with the bulk media purchase data or keep the data separate.

The media purchase data may also include purchases specifically identified as being from movie theaters. The movie theater purchases may include a time of transaction, date of transaction and an account number associated with the transaction. Based on a movie theater purchase, the media purchase tracking device 120 may assume or approximate a number of tickets purchased and which movie was attended. For example, the media purchase tracking device 120 may estimate an amount spent on tickets, for example if the movie theater purchase appears to also include food and drink item(s), and may estimate a number of tickets based on prior history or a number of family members associated with the account number. The media purchase tracking device 120 may obtain a list of movie showtimes for the movie theater and may then determine which movie was watched based on the movie showtimes, the number of tickets sold, the amount spent on tickets, and/or the number of family members or prior history. For example, if a family of four purchases movie tickets at 6:00 PM, the media purchase tracking device 120 may determine that the family is attending a 6:15 showing of a PG rated film as opposed to a 6:30 showing of an R rated film. The purchase tracking device 120 may make assumptions based on rules relating to stored information in the payment account data warehouse 154. The media purchase tracking device 120 may then store the PG rated film as a media content item associated with the corresponding account number.

Alternatively, the media purchase tracking device 120 may approximate ticket purchases based on total ticket sales for the movie theater. For example, the media purchase tracking device 120 may allocate ticket purchases based on the viewing times and the total sales per day. For example, if 60% of ticket sales were for Movie A and 40% for Movie B, the media purchase tracking device 120 may attribute 60% of each ticket purchase towards Movie A and the remaining 40% towards Movie B.

In another implementation the media purchase tracking device 120 may receive media purchase data from a third party data source such as the first vendor server 114, the second vendor server 116 and/or additional vendor servers (not shown). Vendor servers may be associated with one or more media content providers and may provide different types of media purchase data.

For example, the first vendor server 114 may be associated with online streaming subscriptions, such as Fandango, Amazon, Apple, Best Buy or the like, and may provide media purchase data listing media content item(s) viewed and/or otherwise consumed and the date of consumption. If the online streaming subscription is a flat rate service, the media purchase data may not include typical transaction data such as an amount of transaction, but may include transaction data associated with the subscription itself. However, some online streaming subscriptions may allow rentals for certain media content items, so the media purchase data may include transaction data for rental(s) in addition to the transaction data associated with the subscription itself. While the media purchase data may include reference numbers associated with the online streaming subscriptions, the reference numbers provided may not correspond to account numbers utilized by the media purchase tracking device 120. Thus, the media purchase tracking device 120 may cross reference the media purchase data with the payment account data provided by the payment account data warehouse 154 to determine corresponding account numbers. For example, the media purchase tracking device 120 may associate a reference number with an account number using the transaction data for rental(s) and/or the transaction data associated with the subscription.

The second vendor server 116 may be associated with an online store, such as iTunes, Amazon.com or the like and may provide media purchase data listing media content item(s) downloaded and/or otherwise purchased and the date of purchase. As discussed above, the media content item(s) may include video content, audio content, video game content or any other content available for purchase in the online store. While the media purchase data may include reference numbers associated with individual media purchase transactions, the reference numbers provided may not correspond to account numbers utilized by the media purchase tracking device 120. Thus, the media purchase tracking device 120 may cross reference the media purchase data with the payment account data provided by the payment account data warehouse 154 to determine corresponding account numbers. For example, the media purchase tracking device 120 may associate a reference number with an account number using payment account data such as dollar amount, merchant, transaction date/time and/or loyalty card number.

Examples of additional vendor servers may include cable or satellite television services, such as available from Comcast, Dish Network, DirectTV or the like that offer media content item(s), or airline services that offer media content item(s) as a rental. In either example, the media purchase tracking device 120 may receive media purchase data from the additional vendor server, the media purchase data including a list of media purchase transactions and/or a list of media content item(s). Based on the media purchase data, the media purchase tracking device 120 may determine the media content item(s) watched and may associate reference number(s) included in the media purchase data with corresponding account number(s) using the payment account data provided by the payment account data warehouse 154. For example, the media purchase tracking device 120 may associate a reference number with an account number using payment account data such as dollar amount, merchant, transaction date/time and/or loyalty card number.

While FIG. 1 illustrates the media purchase tracking device 120 being separate from the payment account data warehouse 154, the media purchase tracking device 120 may be component within the payment account data warehouse 154, or the payment account data warehouse 154 may be a storage system or memory that is integrated with the media purchase tracking device 120, without departing from the disclosure. In addition, the media purchase tracking device 120 may connect with devices not shown in FIG. 1 without departing from the present disclosure.

Note that while the media purchase tracking device 120 may associate media purchase data with account number(s), the media purchase tracking device 120 may also associate media purchase data with viewer identifier(s) derived from the account number(s) or use other methods to provide the media purchase data anonymously.

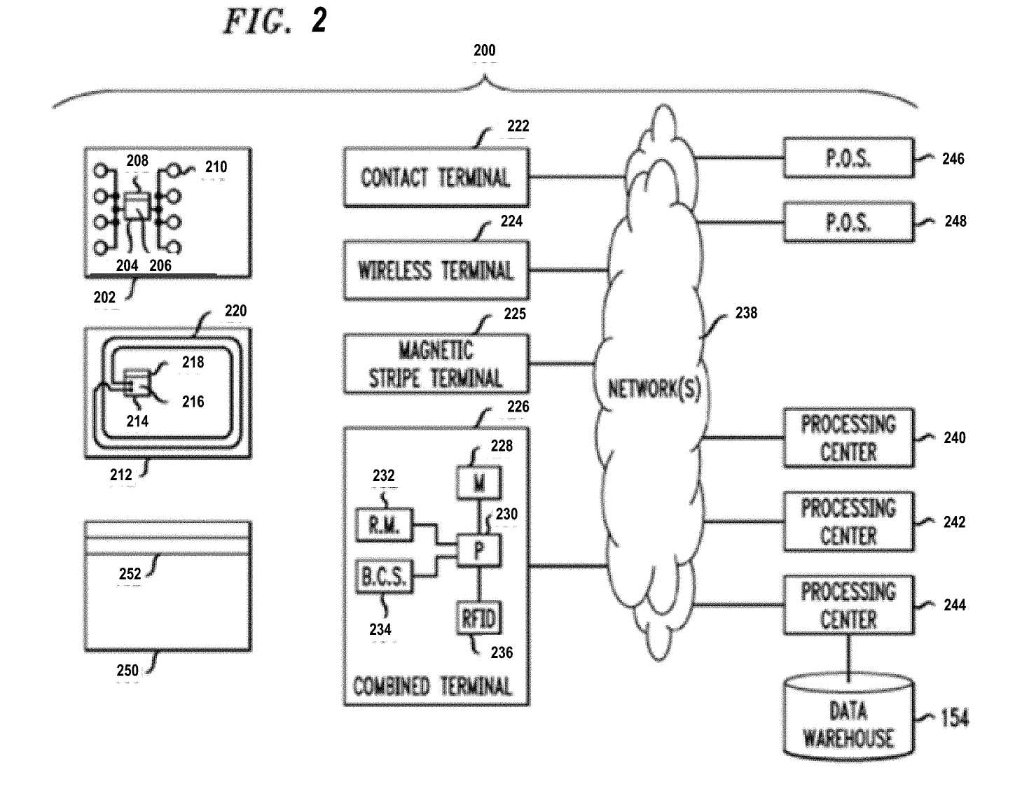

FIG. 2 is a conceptual block diagram illustrating an example of a credit card or payment processing transaction system according to aspects of the present disclosure. A system for payment transaction processing and tracking media content purchase characteristics of an individual or a population segment according to an aspect of the present disclosure includes one or more electronic data storage systems coupled in electronic communication to one or more media consumption data sources. Electronic data storage systems may be coupled to media consumption data sources, such as the vendor servers (e.g. 114, 116 of FIG. 1), directly or indirectly by one or more different means for communication such as direct wiring, wireless communication, fiber optics, and may involve communication via one or more intermediate communication network such as the Internet, for example. The media consumption data sources may include various entities, groups or networks that are involved with the tracking of media content and which generate, receive and/or collect media related information. Media content data sources may include SKU data cooperatives that accumulate purchase details from thousands of retailers (some SKUs can be readily associated with media content purchases), online streaming subscription providers, the online stores, cable or satellite television services, or airline services, for example. Such media content data sources may be configured to feed data to the credit card or payment processing transaction system according to aspects of the present disclosure, to be associated with an individual's account number in the credit card or payment processing transaction system.

Because a large amount of financial services (e.g. credit card and payment processing) data may at times be subject to various strict privacy policies, regulations or statutes governing the storage and communication of such information, aspects of the present disclosure include systems that may not be configured in a standard technical environment using only standard communication techniques, conventional general purpose computer networks and communication equipment, for example. Rather, aspects of the present disclosure may provide substantial improvements to the conventional technical environments for accessing, storing and/or communicating credit card or payment processing information that include special purpose computer hardware, software, algorithms and/or communication techniques to secure and/or de-identify data and/or to ensure that data is accessed, communicated and stored in a manner that maintains its security and privacy. For example, the system may include special purpose computer hardware, software, algorithms and/or communication techniques or portions thereof that may be implemented by only a small number of industry stakeholders such as credit card issuers or payment processors to ensure data privacy.

FIG. 2 depicts a system 200 including various possible components in a system incorporating a media purchase tracking device 120 according to aspects of the present disclosure. It should be noted that for completeness and generality, presentation of certain physical cards such as known credit or debit cards to certain terminals will be described. However, aspects of the present disclosure involve credit accounts and transaction data that is not dependent on a physical card or terminal, for example. In FIG. 2, the system 200 may include a contact device such as card 202. Card 202 can include an integrated circuit (IC) chip 204 having a processor portion 206 and a memory portion 208. A plurality of electrical contacts 210 can be provided for communication purposes. In addition to or instead of card 202, system 200 can also be designed to work with a contactless device such as card 212. Card 212 can include an IC chip 214 having a processor portion 216 and a memory portion 218. An antenna 220 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 202, 212 are examples of a variety of devices that can be employed for communicating transaction data according to aspects of the present disclosure. Other types of devices used in lieu of or in addition to “smart” or “chip” cards 202, 212 could include a conventional card 250 having a magnetic stripe 252, an appropriately configured cellular telephone handset (not shown), and the like. Indeed, techniques can be adapted to a variety of different types of cards, terminals, and other devices, configured, for example, according to a payment system standard (and/or specification).

The ICs 204, 214 can contain processing units 206, 216 and memory units 208, 218. Preferably, the ICs 204, 214 can also include one or more of control logic, a timer, and input/output ports. Such elements are well known in the IC art and are not separately illustrated. One or both of the ICs 204, 214 can also include a co-processor, again, well-known and not separately illustrated. The control logic can provide, in conjunction with processing units 206, 216, the control necessary to handle communications between memory unit 208, 218 and the input/output ports. The timer can provide a timing reference signal from processing units 206, 216 and the control logic. The co-processor could provide the ability to perform complex computations in real time, such as those required by cryptographic algorithms.

The memory portions or units, such as 208, 218 may include different types of memory, such as volatile and non-volatile memory and read-only and programmable memory. The memory units can store protected transaction card data such as a user's primary account number (“PAN”) and/or personal identification number (“PIN”). The memory portions or units 208, 218 can store the operating system of the cards 202, 212. The operating system loads and executes applications and provides file management or other basic card services to the applications. One operating system that can be used is the MULTOS® operating system licensed by MAOSCO Limited (MAOSCO Limited, St. Andrews House, The Links, Kelvin Close, Birchwood, Warrington, WA3 7PB, United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. The operating system is stored in read-only memory (“ROM”) within memory portion 208, 218. In an alternate embodiment, flash memory or other non-volatile and/or volatile types of memory may also be used in the memory units 208, 218.

As noted, cards 202, 212 are examples of a variety of payment devices that can be employed. Such devices could include cards having a conventional form factor, smaller or larger cards, cards of different shape, key fobs, personal digital assistants (PDAs) or tablets, appropriately configured cell phone handsets, or indeed any device with the appropriate capabilities. The memories 208, 218 can contain appropriate applications. The processors 206, 216 can be operative to implement appropriate functionality. The applications can be, for example, application identifiers (AIDs) linked to software code in the form of firmware plus data in a card memory such as an electrically erasable programmable read-only memory (EEPROM). “Smart” or “chip” cards are not necessarily required and a conventional magnetic stripe card can be employed for initiating media content transactions; furthermore, as noted above, one or more embodiments are of interest wherever credit is extended in a credit account, including accounts having no physical card.

A number of different types of terminals can be employed with system 200. Such terminals can include a contact terminal 222 configured to interface with contact-type device 202, a wireless terminal 224 configured to interface with wireless device 112, a magnetic stripe terminal 225 configured to interface with a magnetic stripe device 250, or a combined terminal 226. Combined terminal 226 is designed to interface with any type of device 202, 212, 250. Some terminals can be contact terminals with plug-in contactless readers. Combined terminal 226 can include a memory 228, a processor portion 230, a reader module 232, and optionally an item interface module such as a bar code scanner 234 and/or a radio frequency identification (RFID) tag reader 236. Items 228, 232, 234, 236 can be coupled to the processor 230. Note that the principles of construction of terminal 226 are applicable to other types of terminals and are described in detail for illustrative purposes. Reader module 232 can be configured for contact communication with card or device 202, contactless communication with card or device 212, reading of magnetic stripe 252, or a combination of any two or more of the foregoing (different types of readers can be provided to interact with different types of cards e.g., contacted, magnetic stripe, or contactless), or other payment devices.

Terminals 222, 224, 225, 226 can be connected to one or more processing centers 240, 242, 244 via computer network(s) 138. Network(s) 238 could include, for example, the Internet, a proprietary network (for example, a virtual private network, such as the BANKNET® virtual private network (VPN) of MasterCard International Incorporated of Purchase, N.Y., USA), a local area network (LAN), a wireless local area network (WLAN) (such as WiFi), Bluetooth, and/or wireless networks, such as a Long Term Evolution (LTE) network, WiMAX network, 3G network, etc. More than one network could be employed to connect different elements of the system. For example, a local area network (LAN) could connect a terminal to a local server or other computer at a retail establishment. A payment network could connect acquirers and issuers. Further details regarding one specific form of payment network will be provided below. Processing centers 240, 242, 244 can include, for example, a host computer of an issuer of a payment device (or processing functionality of other entities discussed in other figures herein). Issuers can include issuers for cardless credit card accounts as well.

Many different retail or other establishments providing media content purchase/rental/license data, as well as other entities, generally represented by points-of-sale 246, 248, can be connected to network(s) 238. Different types of portable payment devices, terminals, or other elements or components can combine or “mix and match” one or more features depicted on the exemplary devices in FIG. 2.

Portable payment devices can facilitate transactions by a user with a terminal, such as 222, 224, 225, 226, of a system such as system 200. Such a device can include a processor, for example, the processing units 206, 216 discussed above. The device can also include a memory, such as memory portions 208, 218 discussed above, that is coupled to the processor. Further, the device can include a communications module that is coupled to the processor and configured to interface with a terminal such as one of the terminals 222, 224, 225, 226. The communications module can include, for example, the contacts 210 or antennas 220 together with appropriate circuitry (such as the aforementioned oscillator or oscillators and related circuitry) that permits interfacing with the terminals via contact or wireless communication. The processor of the apparatus can be operable to implement appropriate functionality. The processor can be improved to perform such operations as described herein via hardware techniques, and/or under the influence of program instructions, such as an application, stored in one of the memory units.

Again, conventional magnetic stripe cards 250 can be used instead of or together with “smart” or “chip” cards, and again, cards and other payment devices are described for completeness.

It will be appreciated that the terminals 222, 224, 225, 226 are examples of terminal apparatuses for interacting with a payment device of a holder. The apparatus can include a processor such as processor 230, a memory such as memory 228 that is coupled to the processor 230, and a communications module 232 that is coupled to the processor 230 and configured to interface with the portable apparatuses 202, 212, 242. The processor 230 can be operable to communicate with portable payment devices of a user via the communications module 232. The terminal apparatuses can function via hardware techniques in processor 230, or by program instructions stored in memory 228. Such logic could optionally be provided from a central location such as processing center 240 over network(s) 238. The aforementioned bar code scanner 234 and/or RFID tag reader 236 can optionally be provided, and can be coupled to the processor, to gather attribute relating to media content consumption information, such as a product identification, from a SKU, UPC code or RFID tag on a media content product to be purchased, rented, licensed or the like.

The above-described devices 202, 212 can be ISO 7816-compliant contact cards or devices or NFC (Near Field Communications) or ISO 14443-compliant proximity cards or devices, for example. In operation, card 212 can be touched or tapped on the terminal 224 or 228, which then transmits the electronic data to the proximity IC chip in the card 212 or other wireless device. Magnetic stripe cards can be swiped in a well-known manner. In some instances, the card number is simply provided via web site, in a card-not present transaction or the like.

One or more of the processing centers 240, 242, 244 can include a database such as a data warehouse 154; for example, to hold transaction data as described below. It should be understood by persons skilled in the relevant arts that a database or data warehouse 154 may be directly linked to the one or more processing centers 240, 242, 244 or may be linked to the processing centers via the network(s) 238, for example.

In the context of card-not-present Internet transactions, the card or other device is not presented to terminal 222, 224, 225, or 226. Rather, appropriate account information (e.g., primary account number (PAN), cardholder name, cardholder address, expiration date, and/or security code, and so on) is provided to a merchant by a consumer using a web site or the like. The merchant then uses this information to initiate the authorization process.

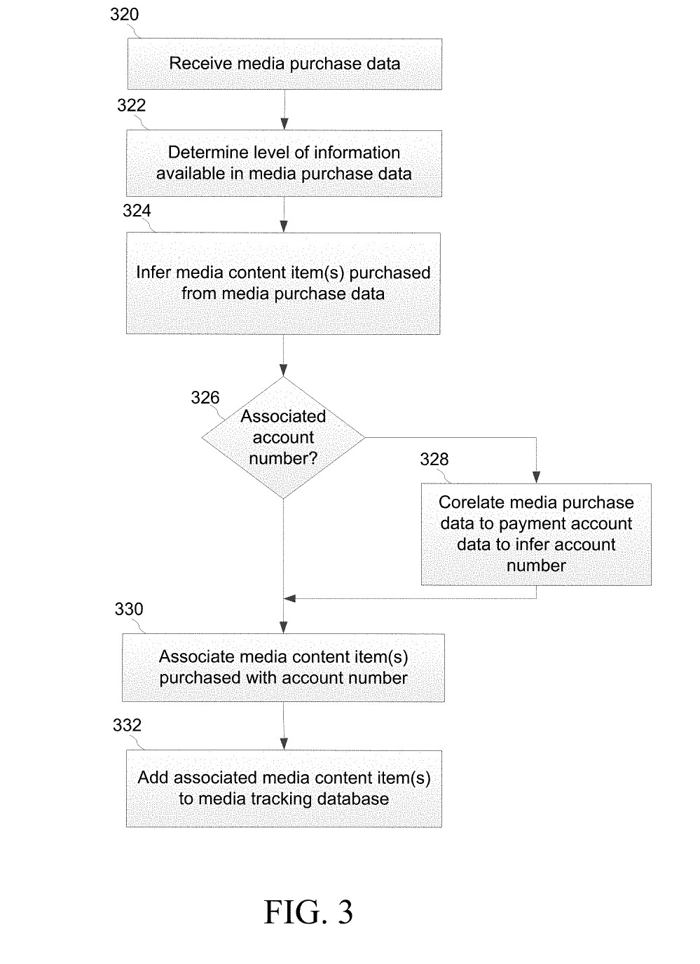

FIG. 3 is a block diagram illustrating a general example of a method for tracking media purchases according to aspects of the present disclosure (it should be appreciated that the term “purchase” as used includes rental, lease, licensing transactions or the like). As illustrated in FIG. 3, the media purchase tracking device 220 may receive (320) media purchase data and may parse the data to determine (322) the level of information available in the media purchase data. In a first example, the media purchase tracking device 220 may receive bulk media purchase data from the bulk media server 212 and may determine that the bulk media purchase data includes SKU level detail associated with the purchase of media content item(s) and corresponding transaction data. In a second example, the media purchase tracking device 220 may receive media purchase data from the first vendor server 214 associated with online streaming subscriptions and may determine that the media purchase data includes media content item(s) viewed but omits transaction data associated with the media content item(s). As a third example, the media purchase tracking device 220 may receive media purchase data associated with a movie theater and may determine a level of information available in the media purchase data.

The media purchase tracking device 220 may infer (324) media item(s) purchased from media purchase data. In the first example, the media purchase tracking device 220 may use the SKU level detail as a list of the media content item(s). In the second example, the media purchase tracking device 220 may use the media content item(s) viewed as a list of the media content item(s). In the third example, the media purchase tracking device 220 may estimate or approximate the media content item(s) viewed based on the transaction data included in the media purchasing data and public information such as movie times.

The media purchase tracking device 220 may determine (326) if media content item(s) are associated with an account number. In some examples, the media purchase tracking device 220 may determine that the media content item(s) are already associated with an account number. For example, clearing addenda associated with payment account data may include SKU level details and may be associated with the account number included in the payment account data. If the media content item(s) are not associated with an account number, the media purchase tracking device 220 may correlate (328) media purchase data associated with media item(s) to payment account data to infer the account number. For example, the media purchase tracking device 220 may associate media content item(s) with an account number using payment account data such as dollar amount, merchant, transaction date/time and/or loyalty card number.

The media purchase tracking device may associate (330) media item(s) with a corresponding account number and may add (332) associated media content item(s) to a media tracking database. These may be separate steps or may be combined as a single step based on the location and complexity of the media tracking database. For example, if the media tracking database is remote to the media purchase tracking device 220, the media purchase tracking device 220 may associate (330) the media item(s) with a corresponding account number locally and may add (332) associated media content item(s) to a remote media tracking database by transmitting data to the media tracking database. In contrast, if the media tracking database is stored within the media purchase tracking device 220, the media purchase tracking device 220 may simultaneously associate (330) and add (332) without requiring two separate steps.

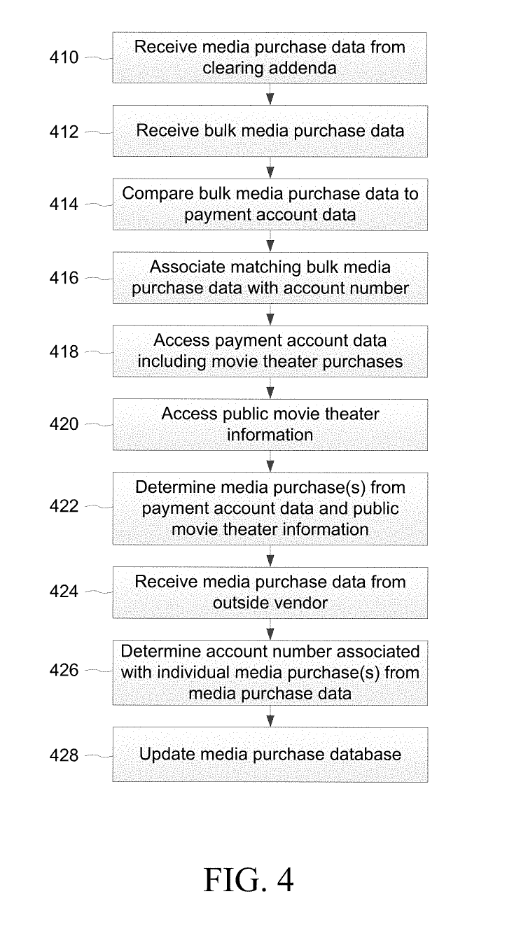

FIG. 4 is a block diagram illustrating a general example of a method for updating a media purchase database according to aspects of the present disclosure. FIG. 4 is provided merely as an example, the method is not limited to the order illustrated in FIG. 4.

The media purchase tracking device may receive (410) media purchase data from clearing addenda associated with media purchase data provided by the payment account data warehouse 154. The clearing addenda may provide SKU level detail and may be associated with an account number.

The media purchase tracking device may receive (412) bulk media purchase data, compare (414) the bulk media purchase data to payment account data and associate (416) matching bulk media purchase data with a corresponding account number. Thus, the media purchase tracking device 220 may cross reference the bulk media purchase data with the payment account data provided by the payment account data warehouse 154 to determine corresponding account numbers. For example, the media purchase tracking device 220 may associate a transaction included in the bulk media purchase data with a corresponding account number using payment account data such as dollar amount, merchant, transaction date/time and/or loyalty card number.

The media purchase tracking device 220 may access (418) payment account data including movie theater purchases, access (420) public movie theater information and determine (422) media purchase(s) from the payment account data and the public movie theater information. For example, the movie theater purchases may include a time of transaction, date of transaction and an account number associated with the transaction. Based on a movie theater purchase, the media purchase tracking device 220 may assume or approximate a number of tickets purchased and which movie was attended. For example, the media purchase tracking device 220 may estimate an amount spent on tickets, for example if the movie theater purchase appears to also include food and drink item(s), and may estimate a number of tickets based on prior history or a number of family members associated with the account number. The media purchase tracking device 220 may obtain a list of movie showtimes for the movie theater and may then assume which movie was watched based on the movie showtimes, the number of tickets sold, the amount spent on tickets, and/or the number of family members or prior history.

The media purchase tracking device 220 may receive (424) media purchase data from outside vendors. For example, the media purchase tracking device 220 may receive media purchase data from an online streaming subscription listing media content item(s) viewed and/or otherwise consumed and the date of consumption. Alternatively, the media purchase tracking device 220 may receive media purchase data from an online store listing media content item(s) downloaded and/or otherwise purchased and the date of purchase. As another example, the media purchase tracking device 220 may receive media purchase data from cable television services that offer media content item(s) or airline services that offer media content item(s) as a rental. The media purchase data may include a list of media purchase transactions and/or a list of media content item(s). Based on the media purchase data, the media purchase tracking device 220 may determine the media content item(s) watched.

The media purchase tracking device 220 may determine (426) account number(s) associated with individual media purchase(s) from media purchase data. For example, the media purchase tracking device 220 may associate a reference number with an account number using transaction data and payment account data such as dollar amount, merchant, transaction date/time and/or loyalty card number.

The media purchase tracking device 220 may update (428) a media purchase database with the media content item(s) and corresponding account number(s). For example, the media purchase tracking device 220 may update an internal database or may transmit the data to an external database.

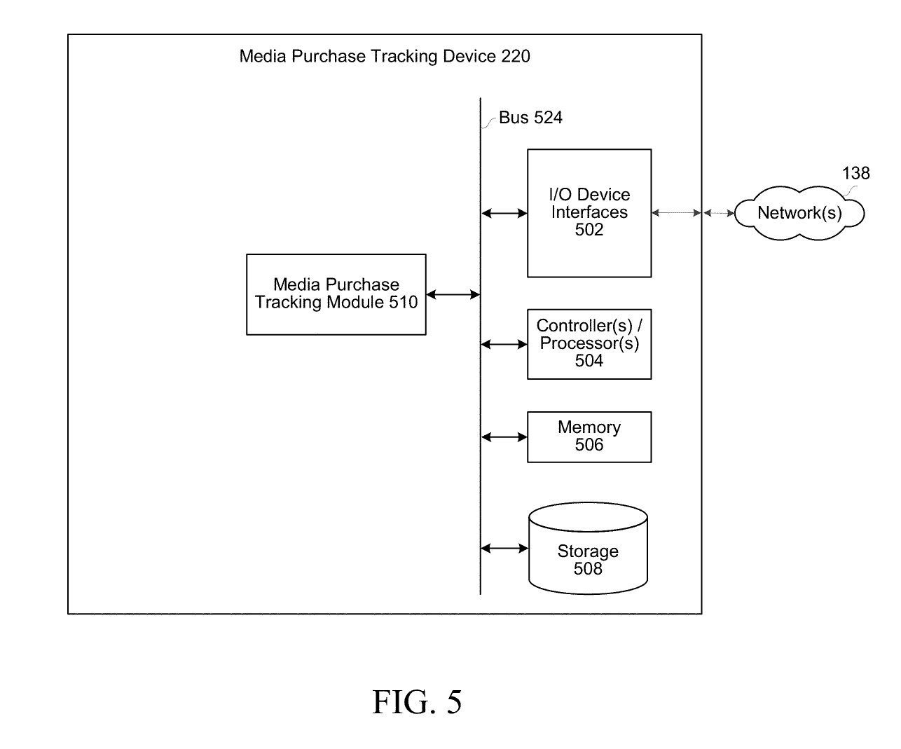

FIG. 5 illustrates block diagrams conceptually illustrating components of a Media Purchase Tracking Device 220. Depending upon how the system is structured, some of the components illustrated in FIG. 5 as part of the Media Purchase Tracking Device 220 may be distributed across multiple devices. Other components not illustrated may also be included in the Media Purchase Tracking Device 220. In operation, the system may include computer-readable and computer-executable instructions that reside in storage 508 on the Media Purchase Tracking Device 220. The Media Purchase Tracking Device 220 may be a computer, a group of computers, a single server or a group of servers.

The teachings of the present disclosure may be applied within a number of different devices and computer systems, including, for example, server-client computing systems, mainframe computing systems, telephone computing systems, laptop computers, cellular phones, personal digital assistants (PDAs), tablet computers, other mobile devices, etc.

The Media Purchase Tracking Device 220 may include one or more controllers/processors 504 comprising one-or-more central processing units (CPUs) for processing data and computer-readable instructions, and a memory 506 for storing data and instructions. The memory 506 may include volatile random access memory (RAM), non-volatile read only memory (ROM), non-volatile magnetoresistive (MRAM) and/or other types of memory. The Media Purchase Tracking Device 220 may also include a data storage component 508 for storing data and processor-executable instructions. The data storage component 508 may include one or more non-volatile storage types such as magnetic storage, optical storage, solid-state storage, etc. The Media Purchase Tracking Device 220 may also be connected to a removable or external non-volatile memory and/or storage (such as a removable memory card, memory key drive, networked storage, etc.) through the input/output device interfaces 502.

Executable instructions for operating the Media Purchase Tracking Device 220 and their various components may be executed by the controller(s)/processor(s) 504, using the memory 506 as temporary “working” storage at runtime. The executable instructions may be stored in a non-transitory manner in non-volatile memory 506, storage 508, or an external device. Alternatively, some or all of the executable instructions may be embedded in hardware or firmware in addition to or instead of software.

As shown in FIG. 5, the Media Purchase Tracking Device 220 may be configured to operate with network(s) 138, for example the Internet, a proprietary network (for example, a virtual private network, such as the BANKNET® virtual private network (VPN) of MasterCard International Incorporated of Purchase, N.Y., USA), a local area network (LAN), a wireless local area network (WLAN) (such as WiFi), Bluetooth, and/or wireless networks, such as a Long Term Evolution (LTE) network, WiMAX network, 3G network, etc.

The I/O device interfaces 502 may connect to a variety of components and networks. Among other things, the I/O device interfaces 502 may include an interface for an external peripheral device connection such as universal serial bus (USB), FireWire, Thunderbolt or other connection protocol. The input/output device interfaces 502 may also support a variety of networks via an Ethernet port and/or a wireless interface (not shown).

As discussed above, Media Purchase Tracking Device 220 includes controller(s)/processors 504, memory 506, and storage 508. In addition, the Media Purchase Tracking Device 220 may include a Media Purchase Tracking Module 510, each of which may comprise processor-executable instructions stored in storage 508 to be executed by controller(s)/processor(s) 504 (e.g., software, firmware), hardware, or some combination thereof. For example, components of the Media Purchase Tracking Module 510 may be part of a software application running in the foreground and/or background on the Media Purchase Tracking Device 220. Other configurations are also possible.

The Media Purchase Tracking Module 510 may be configured to receive bulk media purchase data, media purchase data and payment account data and may collate the media content item(s) and corresponding account number(s) into a media purchase database.

The Media Purchase Tracking Module 510 may be connected to the bus 524, input/output interfaces 502, controller/processor 504, and/or other component of the Media Purchase Tracking Device 220. For example, data sent to the Media Purchase Tracking Module 510 may come from the storage 508 or the input/output interfaces 502, such as data sent to the Media Purchase Tracking Device 220 over a network, as well as any other component located in the Media Purchase Tracking Device 220.

Improved systems, methods and computer program products are provided according to the disclosure. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

The computer systems and servers described herein each contain a memory that will configure associated processors to implement methods, steps, and functions described. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the methods, steps and logic described.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Various databases used herein may include: consumer data; third party institution data; and/or like data useful in the operation of the system. As those skilled in the art will appreciate, the consumer may use a computer in the method described and the user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as assessing, determining, matching or selecting, which are commonly associated with mental operations performed by a human operator. No such capability of a human operator is necessary in any of the operations described herein. Rather, the operations may be machine operations. After reading this description, it will become apparent to a person skilled in the relevant art(s) how to implement various embodiments using other computer systems and/or architectures.

Any such computer system also includes a main memory, such as for example random access memory (RAM), and may also include a secondary memory or a removable storage unit. Removable storage unit represents a floppy disk, magnetic tape, optical disk, etc. which is read by and written to by removable storage drive. As will be appreciated, the removable storage unit includes a computer usable storage medium having stored therein computer software and/or data.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, software may be implemented in hardware components such as application specific integrated circuits (ASICs). Implementation of a hardware state machine to perform the functions described herein will be apparent to persons skilled in the relevant art(s).

Databases or data warehouses discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, steps described and the descriptions thereof may comprise configurations of and make reference to user windows, pop-up windows, webpages, websites, web forms, prompts, or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

1.-14. (canceled)

1. A computer implemented media purchase tracking device comprising:
a memory;
at least one processor operatively coupled to the memory; and
a persistent storage device operatively coupled to the memory and storing in a non-transitory manner instructions that when loaded into the memory cause the at least one processor to be operative to:
receive accumulated media purchase transactions to determine media purchase data, the media purchase data being determined from one of clearing addenda associated with payment account data, and payment account data including dollar amount, merchant, transaction date/time or loyalty card number;
determine purchased media items from the accumulated media purchase transactions;
associate the purchased media items with an account number of one or more account numbers in a media tracking database;
track media content purchase characteristics of an individual or a population segment based on the purchased media items associated with one or more account numbers in the media tracking database.

2. The system of claim 1, wherein the media purchase data in the form of clearing addenda has SKU level details listing the purchased media items.

3. The system of claim 1, wherein the accumulated media purchase data is bulk media purchase data based on combined transactions from thousands of retailers.

4. The system of claim 1, wherein the instructions cause the at least one processor to:
access public movie theater information, and
determine the purchased media items from the first media purchase transaction of the accumulated media purchase transactions and the public movie theater information.

5. The system of claim 4, wherein the instructions cause the at least one processor to:
infer the purchased media items based on showtimes included in the public movie theater information and a time of the first media purchase transaction.

6. The system of claim 1, the instructions cause the at least one processor to:
determine a level of information available in the first media purchase transaction of the accumulated media purchase transactions.

7. The system of claim 1, wherein the instructions cause the at least one processor to:
compare time, location and amount of a first media purchase transaction to a time, location and amount of each of the one or more transactions in the payment account data to infer the first account number from the one or more account numbers.

8. A computer implemented media consumption tracking device method of tracking media purchases of an individual or population segment, the method comprising:
retrieving, by the media consumption tracking device, payment account data from an account database, the payment account data including one or more transactions associated with one or more account numbers within a period of time;
receiving, by the media consumption tracking device, media consumption data, the media consumption data including accumulated media purchase, lease or license transactions;
determining, by the media consumption tracking device, purchased media items from the media consumption data including accumulated media purchase, lease or license transactions, and associating the media consumption data with an account number from the one or more account numbers;
generating by the media consumption tracking device a media purchase tracking database tracking media content purchase characteristics of the individual or the population segment, by storing the media consumption data associated with a respective account number from the one or more account numbers; and
updating the media purchase tracking database with consumption data associated with corresponding account number for tracking media content purchase characteristics of the individual or the population segment based on the media tracking database.

9. The computer implemented method of claim 8, wherein the media purchase data includes clearing addenda listing the purchased media items.

10. The computer implemented method of claim 8, wherein the accumulated media purchase data is bulk media purchase data based on combined transactions from thousands of retailers.

11. The computer implemented method of claim 8, further comprising:
accessing, by the computer, public movie theater information,
wherein the determining of the purchased media items by the computer comprises determining the purchased media items from a first media purchase transaction included in the media consumption data and the public movie theater information.

12. The computer implemented method of claim 11, wherein the determining of the purchased media items further comprises:
inferring the purchased media items based on showtimes included in the public movie theater information and a time of the first media purchase transaction.

13. The computer implemented method of claim 8, further comprising:
determining, by the computer, a level of information available in a first media purchase transaction of the accumulated media purchase transactions.

14. The computer implemented method of claim 8, wherein the comparing by the computer compares a time, location and amount of a first media purchase, lease or license transaction in the media consumption data to a time, location and amount of each of the one or more transactions in the payment account data to infer the first account number from the one or more account numbers.

15. A computer implemented media purchase tracking device tracking media purchases of an individual or population segment, comprising:
at least one processor operatively coupled to the memory, the at least one processor configured to retrieve payment account data from an account database, the payment account data including one or more transactions associated with one or more account numbers within a period of time, the at least one processor configured to receive media consumption data including accumulated media purchase, lease or license transactions, and determine purchased media items from the media consumption data including accumulated media purchase, lease or license transactions, and to associate the media consumption data with an account number from the one or more account numbers;
a persistent storage memory operatively couple to the at least one processor, the persistent storage memory including a media purchase tracking database tracking media content purchase characteristics of the individual or the population segment, by storing the media consumption data associated with a respective account number from the one or more account numbers, and the at least one processor updating the media purchase tracking database in the persistent storage memory with consumption data associated with corresponding account number for tracking media content purchase characteristics of the individual or the population segment.

16. The computer implemented media purchase tracking device according to claim 15 wherein media consumption includes at least one of rental, lease, and licensing transactions.

17. The computer implemented media purchase tracking device according to claim 15, wherein media consumption data is in the form of clearing addenda that has SKU level details listing purchased media items.

18. The computer implemented media purchase tracking device according to claim 15, wherein media consumption data is bulk media purchase data based on combined transactions from thousands of retailers.

19. The computer implemented media purchase tracking device according to claim 15, wherein the media consumption data is public movie theater information.

20. The computer implemented media purchase tracking device according to claim 19, wherein the at least one processor infers purchased media items based on showtimes included in the public movie theater information and a time of the first media purchase transaction.
